(19) United States
(12) Patent Application Publication
(10) Pub. No.: US 2006/0214329 A1
(43) Pub. Date: Sep. 28, 2006

(54) Moulding method and apparatus

(76) Inventor: Jan Petrus Human, Somerset West (ZA)

Correspondence Address: STITES & HARBISON PLLC, 1199 NORTH FAIRFAX STREET, SUITE 900, ALEXANDRIA, VA, 22314, US

(21) Appl. No.: 10/566,242

(22) PCT Filed: Jul. 23, 2004
(86) PCT No.: PCT/ZA04/00082

§ 371 Date: Jan. 30, 2006

(30) Foreign Application Priority Data
Jul. 31, 2003 (ZA) 03/5913
Aug. 8, 2003 (ZA) 03/6145
Aug. 22, 2003 (ZA) 03/6624

(51) Int. Cl. B29C 43/02

(52) U.S. Cl. 264/320; 425/576

(57) ABSTRACT

A method of moulding is disclosed which comprises opening a mould by separating one mould component (16) from another mould component (18) to provide a space which opens upwardly. A lower part of the space is in the form of a well (W). A charge of mouldable material is fed into the space from above so that the charge falls into the well. The mould is closed by displacing the mould components (16, 18) into contact with one another thereby to define a closed moulding cavity which is extended downwardly by the well. The volume of the well is then reduced by displacing a plunger (22) which bounds the bottom of the well relatively to the mould components thereby to displace mouldable material from the well into the moulding cavity and fill said moulding cavity.

### FIELD OF THE INVENTION

THIS INVENTION relates to moulding apparatus and to a method of moulding. It also relates to a cap for a container.

### BACKGROUND TO THE INVENTION

Compression moulding and injection moulding are the two most widely used techniques in the production of articles using synthetic plastics material. In compression moulding a series of upwardly open female moulds move in a circle on a carousel. As each mould passes a material feed zone, a charge of synthetic plastics material is placed in the mould. As the female mould moves away from the feed zone, the female mould comes into cooperating relationship with a male mould which has two relatively movable parts. The first part, which is in the form of a sleeve, contacts the female mould thereby to seal-off a cavity which lies between the male and female moulds. No moulding pressure is exerted on the charge of plastics material on closing of the mould by the sleeve. Once the cavity has been closed, a plunger forming the second part of the male mould is forced into the female mould. The charge of synthetic plastics material is forced by the plunger to take up the shape of the mould cavity which is defined between the plunger and the female mould. During a further part of the movement of the two moulds in the circle defined by the carousel, the synthetic plastics material is cooled so that it freezes. Shortly before the moulds return to the feed zone, the two moulds separate and the moulded article is ejected.

A limitation of compression moulding is that it cannot be used to produce an article with openings in it. To produce an opening it is necessary for the plunger and the female mould to come into contact with one another. However, inevitably there is plastics material between the plunger and the female mould which means that, in the moulded article, there is a film across the opening. Furthermore, the plastics material does not flow in a satisfactory manner around the contacts parts as they move towards one another. The moulded article is as a consequence not of acceptable quality.

Injection moulding is a procedure which involves closing a mould and, once the mould is closed, forcing into it a stream of molten synthetic plastics material. The pressures required to cause the plastics material to flow into all parts of the mould cavity are high, and this means that the clamping pressure on the two parts of the mould must be commensurately high. However, injection moulding does have an advantage over compression moulding in that, as a mould is closed before the synthetic plastics material is forced into the mould cavity, articles with holes can be moulded. Thus while injection moulding permits articles to be produced with which have holes in them, power consumption is high and the cost of an injection moulding machine is also high. Another disadvantage of injection moulding as compared to compression moulding is that the rate of production by an injection moulding machine is slower than can be achieved with compression moulding.

The present invention seeks to provide a moulding method and a moulding apparatus which only requires moulding pressure of the magnitude required in compression moulding, but which can mould articles which are as complex as those that can be obtained using injection moulding techniques.

### BRIEF DESCRIPTION OF THE INVENTION

According to one aspect of the present invention there is provided a method of moulding which comprises opening a mould by separating one mould component from another mould component to provide a space which opens upwardly and a lower part of which space is in the form of a well, feeding a charge of mouldable material into said space from above so that the charge falls into the well, closing the mould by displacing said components into contact with one another thereby to define a closed moulding cavity which is extended downwardly by said well, and reducing the volume of said well by displacing a plunger which bounds the bottom of the well relatively to the mould components thereby to displace mouldable material from said well into said moulding cavity and fill said moulding cavity.

In the preferred form the method comprises displacing the plunger upwardly relatively to said mould components to reduce the volume of said well.

In another form the method comprises displacing said mould components downwardly with respect to the plunger to reduce the volume of said well. In yet another form the method comprises displacing an upper mould component downwardly into contact with a lower mould component thereby to close said moulding cavity, and displacing said components in unison downwardly with respect to said plunger whilst maintaining said plunger in a fixed position.

It is also possible to displace an upper mould component downwardly into contact with a lower mould component thereby to close said moulding cavity, and thereafter displace said plunger upwardly relatively to said mould components.

In a still further embodiment of the method the lower mould component and said plunger are displaced upwardly as a unit towards a fixed upper mould component until said lower mould component contacts said upper mould component, and thereafter said plunger is displaced upwardly with respect to the stationary mould components.

It is also possible for said lower mould component and said plunger to be displaced upwardly as a unit towards a fixed upper mould component until said lower mould component contacts said upper mould component, for said plunger to be immobilized and for said mould components thereafter to be forced downwardly with respect to said immobilized plunger.

According to a further aspect of the present there is provided a moulding apparatus comprising an upper mould component, a lower mould component, means for displacing said components between a closed position in which they bound a moulding cavity and an open position in which the lower component defines an upwardly open space, a lower part of said space being in the form of a well which, when the mould components are in contact, constitutes a downward extension of said moulding cavity, means for feeding a charge of mouldable material into said cavity so that it falls into said well, a plunger forming the bottom of said well, and means for displacing said mould components and said plunger relatively to one another thereby to reduce the volume of the well and displace mouldable material out of said well and into said moulding cavity.

The moulding apparatus can include means for displacing said plunger upwardly with respect to the lower mould component to reduce the volume of said well and displace mouldable material out of said well and into said moulding cavity.

In a further form the moulding apparatus includes means for immobilizing said plunger and means for displacing said mould components downwardly with respect to the plunger to reduce the volume of said well and displace mouldable material out of said well and into said moulding cavity.

According to another aspect of the present invention there is provided a method of moulding which comprises feeding a charge of mouldable material into the cavity of a female mould structure comprising a fixed shaft and a reciprocable female mould, closing said cavity by inserting the spigot of a male mould into said cavity, and displacing said male mould and said female mould with respect to said shaft so that the shaft slides into said cavity, said spigot, an end surface of said shaft and surfaces of the female mould defining a mould cavity having the shape of the article to be produced.

Said spigot can have thereon a protruding rib which extends along the spigot at that end of the spigot which is last to enter the cavity, said rib contacting the female mould whereby a slit is moulded into said article. In an alternative form said rib is carried by the female mould and contacts said spigot when the spigot is in the female mould.

A plurality of ribs spaced apart circumferentially can be provided thereby to mould an array of slits.

A number of male moulds and female mould structures can be on rotatable carousels.

According to yet another aspect of the present invention there is provided a cap comprising a skirt, a transverse end wall at one end of the skirt, and a band at the other end of the skirt, the band being connected to the skirt by a plurality of bridges, the inner diameter of the band and the outer diameter of the skirt being such that the skirt can be forced into the band, the portion of the skirt that enters the band having slits therein which are open at the free edge of the skirt.

The present invention also provides a method of capping a container which comprises pressing a cap as defined above onto the neck of the container so that the bridges break and the skirt slides into the band, the band causing said slits to close-up whereby protruding formations on the inside of the band interlock with a protruding formation on the container to prevent the cap being removed without breaking the band.

The band can have a line of weakness so that it breaks upon pressure being applied thereto sufficient to slide it off the skirt.

### BRIEF DESCRIPTION OF THE DRAWINGS

For a better understanding of the present invention, and to show how the same may be carried into effect, reference will now be made, by way of example, to the accompanying drawings in which:—

FIG. 1 is a diagrammatic top plan view of apparatus in accordance with the present invention;

FIG. 2 is an isometric view of moulding apparatus comprising a female mould structure and a male mould;

FIG. 3 is a diagrammatic side elevation, partly in section, of the moulding apparatus of FIG. 2;

FIG. 4 is a pictorial view of a carousel;

FIGS. 5a to 5e illustrate a moulding cycle;

FIGS. 6a to 6e, 7a to 7e and 8a to 8e illustrate other moulding cycles.

FIG. 9 is a pictorial view of a bottle cap from the closed end;

FIG. 10 is a pictorial view of the cap of FIG. 9 from the open end;

FIG. 11 is a section through the cap of FIGS. 9 and 10;

FIG. 12 illustrates the moulding apparatus which produces the cap of FIGS. 9 to 11;

FIG. 13 is a pictorial view looking into the female mould of FIG. 12; and

FIG. 14 illustrates the production of a preform.

### DETAILED DESCRIPTION OF THE DRAWINGS

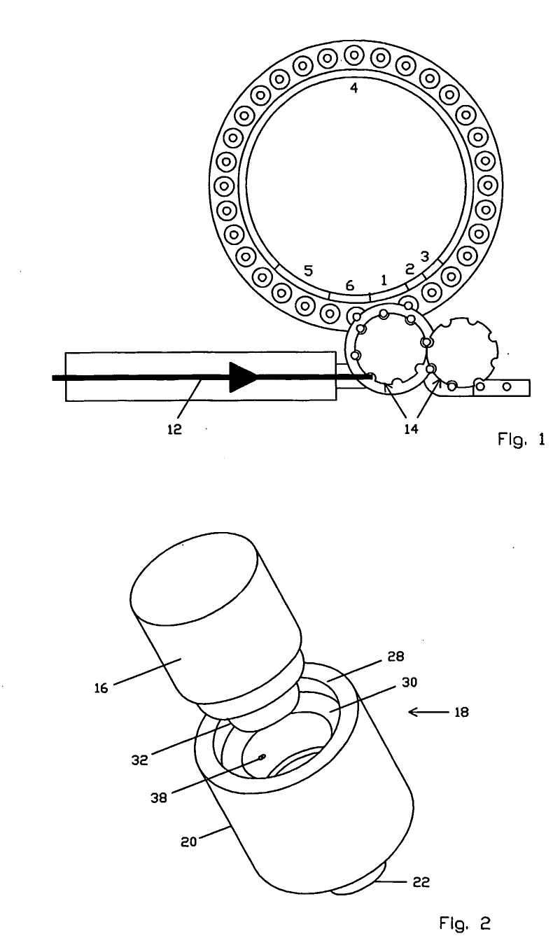

The apparatus of FIG. 1 comprises a rotatable carousel 10 which carries a series of female moulds and a series of male moulds as will be described hereinafter. At the zone designated 1, the male moulds are spaced from, and are above, the female moulds and the female moulds are upwardly open. Synthetic plastics material is fed along the feed path 12 and is divided by a rotatable mechanism 14 into individual charges which fall into the female moulds as they pass zone 1. As each female mould reaches zone 2, it starts to lift. By zone 3 the male mould has entered the female mould. A first part of the male mould closes-off a cavity between the female mould and itself. A plunger forming part of the male mould then enters the female mould. The plunger and the female mould define between them a cavity which has the shape of the article to be produced. The closing moulds force the charge of material to take on the shape of the article being produced. As the closed mould reaches zone 4, cooling commences and at zone 5 the male and female moulds separate. At zone 6 the product is ejected and the cycle starts again. The moulded caps are ejected onto another level of the mechanism 14 and carried to the conveyor shown on the right hand side of FIG. 1 for further processing.

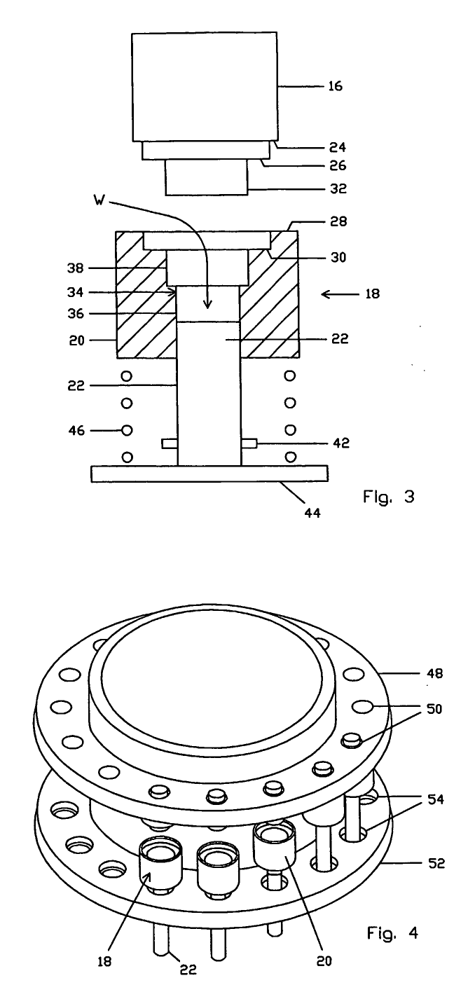

FIGS. 2 and 3 illustrate a male mould 16 and a female mould structure 18 according to the present invention. The structure 18 comprises a movable female mould 20 and a fixed plunger 22.

The male mould 16 is stepped to provide closure surfaces 24, 26 which bear on closure surfaces 28, 30 of the female mould 20. The male mould 16 further includes a spigot 32.

The female mould 20 has a stepped bore 34 through it. The lower part 36 of the bore 34 receives the plunger 22. An intermediate part 38 of the bore 34 forms the external boundary of a mould cavity 40 (see FIGS. 5d and 5e) having the shape of the product to be moulded. In this illustrated form the product is a cap for a bottle.

The plunger 22 has a stop ring 42 around it close to its lower end and the lower end of the plunger 22 is fixed to a plate 44. A spring 46 between the female mould 20 and the plate 44 pushes the mould 20 upwards.

As shown in FIG. 2, the lower mould component defines an upwardly open space into which the charge of mouldable material can be placed. The lower part of the space is in the form of a well W which, when the mould components are in contact, constitutes a downward extension of the moulding cavity. The plunger 22 forms the bottom of the well. When the mould components and the plunger are displaced relatively to one another, the volume of the well is reduced and the mouldable material is displaced out of the well and into the moulding cavity.

In FIG. 4 the male moulds 16 are shown as being carried by a rotatable upper disc 48, the moulds reciprocating in passageways 50 of the disc 48. The female mould structures 20 are carried by a lower disc 52, there being guide passageways 54 in the disc 52. Fixed cams (not shown) move the male moulds and female mould structures towards and away from one another.

In FIG. 5 the male mould 16 is shown in simplified form as including a single sealing surface 26. Likewise the female mould 20 has a single sealing surface 30. The ring 42 has been omitted from FIG. 5. Closing-up of the spring 46 limits downward movement of the female mould 20.

At the beginning of a moulding cycle, the male and female moulds are separated as shown in FIGS. 2, 3, 5a and 5b. This enables a measured charge C (FIGS. 5b and 5c) of synthetic plastics material to be dropped into the female mould structure 18 so that it lies on the upper end of the plunger 22.

The male mould 16 moves downwardly into contact with the female mould 20 which at this time is held in its uppermost position (FIGS. 5a, 5b and 5c) by the spring 46. The upper end of the mould cavity 40 is sealed-off and the male mould 16 continues to move down forcing the female mould 20 to slide down the fixed plunger 22 against the action of the spring 46. Such movement continues until the lower face of the mould 20 closes up the spring 46 which then forms a stop. The mould structure is now as shown in FIG. 5d.

In terms of FIG. 1, FIG. 5a represents the condition at zone 6 and FIG. 5b represents zone 1. FIGS. 5c and 5d represent zones 2 and 3. FIG. 5d is the condition during moulding and cooling (zone 3 and zone 4).

FIG. 5e represents the condition at zone 5 where opening of the mould has taken place prior to ejection at zone 6 of the article A that has been moulded.

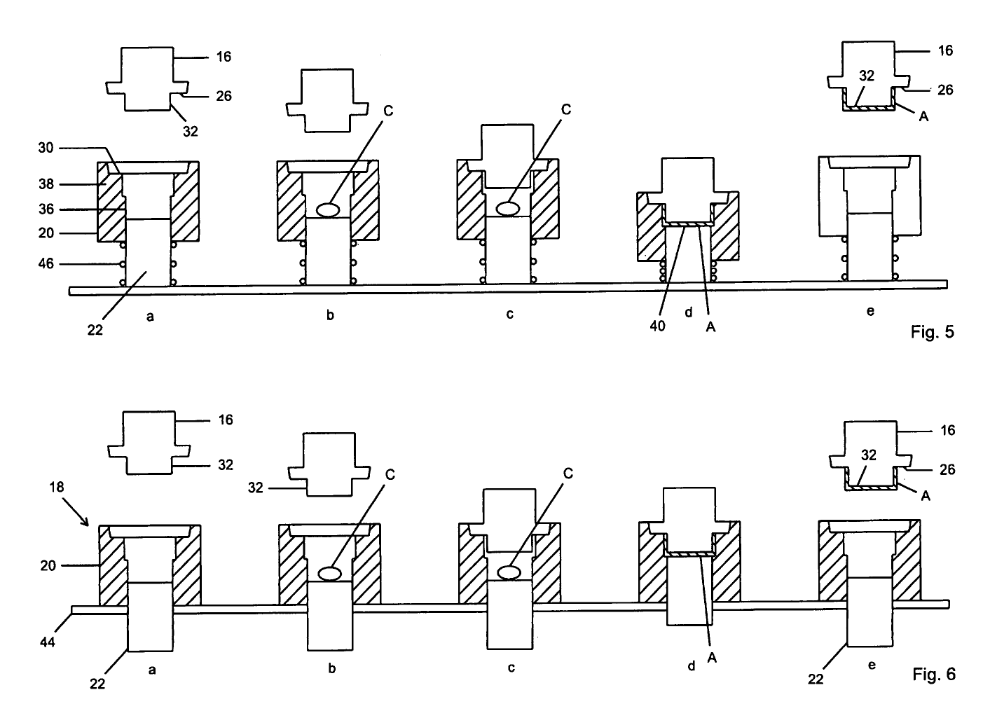

In FIGS. 6a to 6e it is the female mould 20 which is secured to the plate 44. In FIG. 6a the male mould 16 is spaced from and is above the female mould structure 18 so that the charge C can be fed in. In FIG. 6b the male mould 16 has commenced its downward movement. FIG. 6c shows the mould fully closed. The charge C is now in the space bounded by the male mould 16, the female mould 20 and the plunger 22. In FIG. 6d the plunger 22 has moved upwards to force the charge to flow into the cylindrical space between the male and female moulds. This forms the cylindrical skirt of the cap being moulded. The transverse end wall of the cap is moulded between the plunger 22 and the end of the spigot 32. In FIG. 6e the plunger 22 has retracted downwardly and the moulds have separated, the mould 16 having moved upwardly. The moulded article A is on the spigot 32 of the male mould 16.

In FIGS. 7a to 7e, the ring 42 is shown and the spring 46 acts between this and the female mould 20. The male mould 16 is above the female mould structure and it is the female mould structure 18 which initially moves upwardly. In FIG. 7a there is separation between the male mould 16 and the female mould structure 18. In FIG. 7b the charge C has been placed in the female mould structure 18 which then moves upwardly towards the male mould 16. In FIG. 7c the mould is fully closed as the male mould 16 has entered the female mould 20. The plunger 22 at this stage is held by a cam (not shown) so that it becomes immovable, and the male mould 16 encounters a further cam (not shown) which forces it downwardly (FIG. 7d). Downward motion of the female mould 22 is against the action of the spring 46 and continues until the female mould closes up the spring 46 against the ring 42. The male mould is then cammed upwardly so that the components return firstly to the relative position shown in FIG. 7c, then to the position shown in FIG. 7b and finally to the position shown in FIG. 7e which represents zone 5.

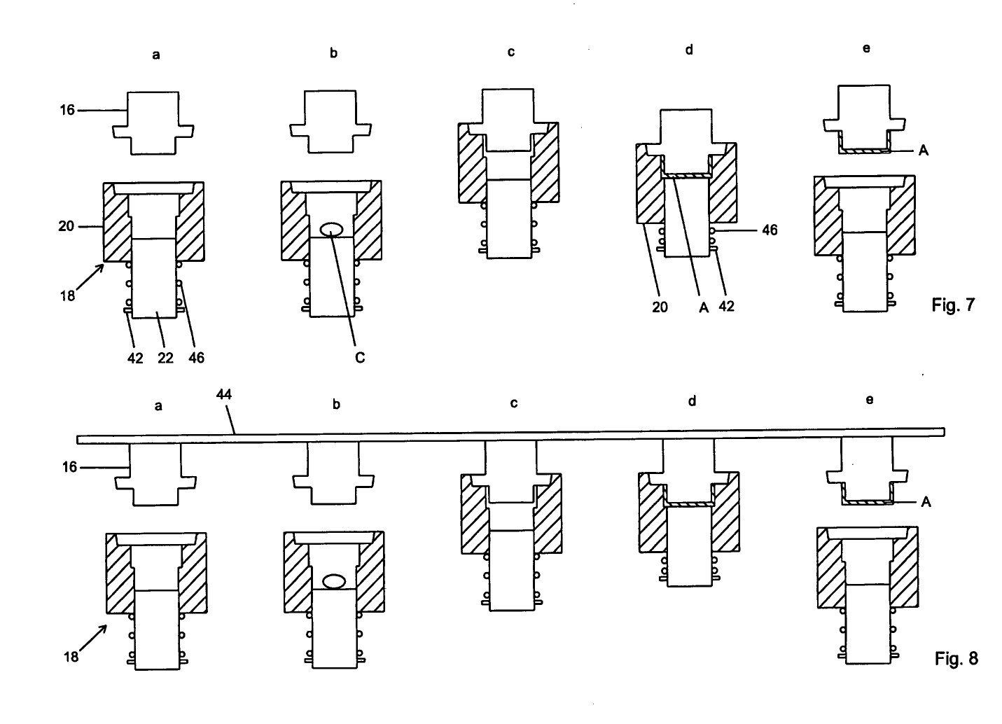

FIGS. 8a to 8e illustrate a sequence which corresponds to that of FIGS. 7a to 7e except in that the male mould 16 is immovably fixed to the plate 44. Thus motion of the plunger 22 upwardly is used to exert moulding pressure, and not downward movement of the male and female moulds relative to the plunger 22.

The plunger 22 can be spring loaded by a spring which is strong enough to exert the moulding pressure. Should the charge of plastics material be over or under weight, the spring compensates for this by moving the plunger slightly further (if the charge is too small) or slightly less distance (if the charge is too large).

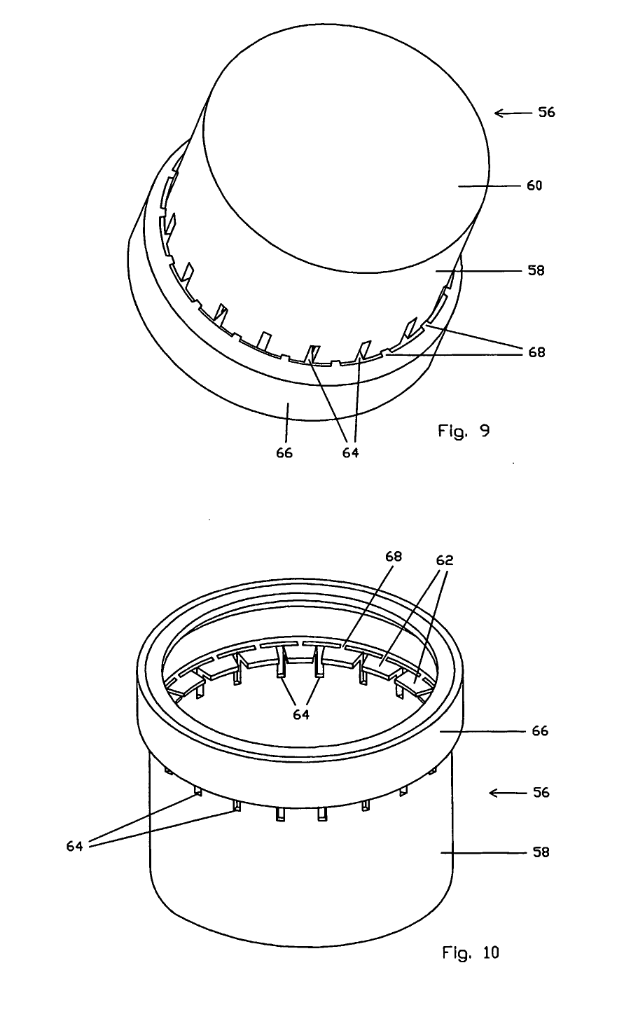

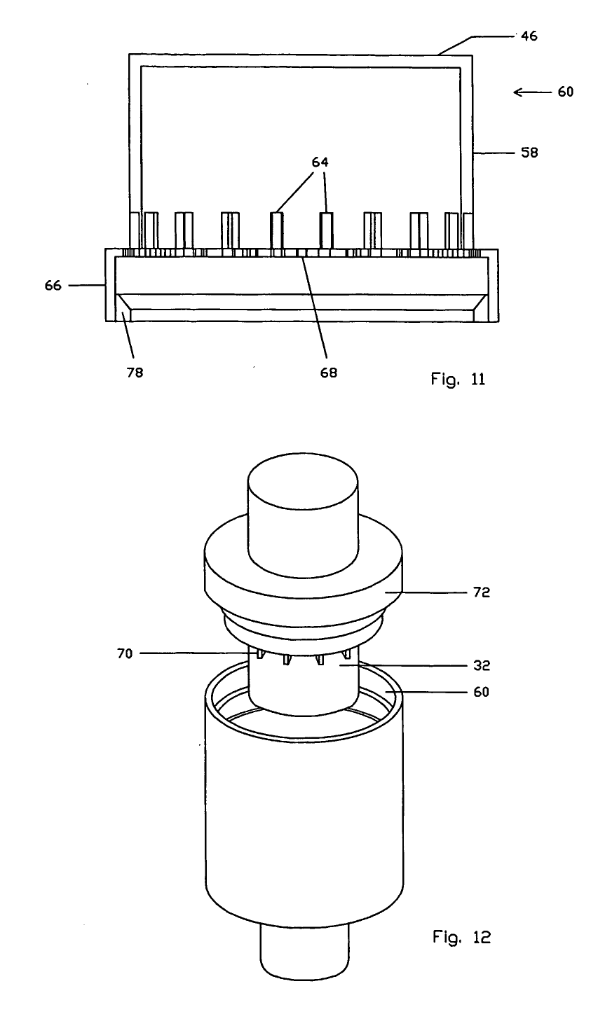

Referring now to FIGS. 9 to 11, the cap 56 comprises a skirt 58 and a transverse end wall 60. On the inside of the skirt 58 there is a raised thread (not shown) which is produced by a corresponding spiral groove in the spigot 32 of the male mould 16. Locking tabs 62 protrude inwardly from the skirt. These co-operate with a bead on the bottle. As the cap is removed, the tabs are forced outward by the bead, and this increases the overall diameter of the cap on this circumference. The skirt 58 also has slits 64 in it which extend axially of the skirt 58 from its free edge and the cap further comprises a band 66 which is joined to the skirt by way of a series of bridges 68 (see FIG. 11).

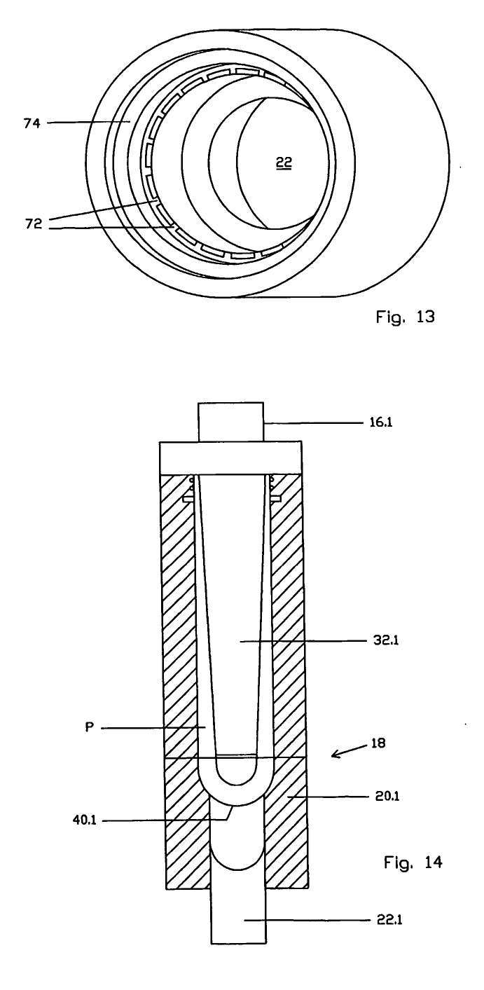

The tool for moulding the cap of FIGS. 9 to 11 is shown in more detail in FIGS. 12 and 13. The spigot 32 is formed with a plurality of ribs 70 where the cylindrical side surface of the spigot 32 meets the closure surface 26. These occupy spaces which would otherwise be occupied by material forming the skirt. Thus the presence of the ribs 70 results in the skirt being moulded with the slits 64.

The surfaces designated 72 and 74 form the inner and outer boundaries of the annular space in which the band 66 is moulded.

As described above the band 66 is connected to the skirt 58 by bridges. These bridges are moulded in the gaps designated 72 in FIG. 13.

The band 66 can be moulded with an internal rib 78 (FIG. 11) which interlocks with a groove (not shown) in the outer surface of the skirt 58 to interlock the band and skirt.

It is also possible in accordance with the invention to mould the band on the inside of the cap, the bridges breaking and the cap sliding over the band during the capping procedure. In this form the cap has lines of weakening so that, on removal, a portion of the cap is broken off to reveal tampering.

In FIG. 14 a mould is disclosed in which a preform P can be manufactured and which is later blown to form a bottle or other container. Like parts have been designated with the same references as used in FIG. 2 with the addition of the suffix 1. The only significant difference between the mould of FIG. 1, and the mould of FIG. 14, resides in the shape of the mould cavity.

1. A method of moulding which comprises opening a mould by separating one mould component from another mould component to provide a space which opens upwardly and a lower part of which space is in the form of a well, feeding a charge of mouldable material into said space from above so that the charge falls into the well, closing the mould by displacing said components into contact with one another thereby to define a closed moulding cavity which is extended downwardly by said well, and reducing the volume of said well by displacing a plunger which bounds the bottom of the well relatively to the mound components thereby to displace mouldable material from said well into said moulding cavity and fill said moulding cavity.

2. A method as claimed in claim 2 and comprising displacing the plunger upwardly relatively to said mould components to reduce the volume of said well.

3. A method as claimed in claim 1 and comprising displacing said mould components downwardly with respect to the plunger to reduce the volume of said well.

4. A method as claimed in claim 3 and comprising displacing an upper mould component downwardly into contact with a lower mould component thereby to close said moulding cavity, and displacing said components in unison downwardly with respect to said plunger whilst maintaining said plunger in a fixed position.

5. A method a claimed in claim 2 and comprising displacing an upper mould component downwardly into contact with a lower mould component thereby to close said moulding cavity, and thereafter displacing said plunger upwardly relatively to said mould components.

6. A method as claimed in claim 1 and comprising displacing a lower mould component and said plunger upwardly as a unit towards a fixed upper mould component until said lower mould component contacts said upper mould component, and thereafter displacing said plunger upwardly with respect to the stationary mould components.

7. A method as claimed in claim 1, and comprising displacing a lower mould component and said plunger upwardly as a unit towards a fixed upper mould component until said lower mould component contacts said upper mould component, immobilizing said plunger, and thereafter forcing said mould components downwardly with respect to said immobilized plunger.

8. Moulding apparatus comprising an upper mould component, a lower mould component, means for displacing said components between a closed position in which they bound a moulding cavity to an open position in which the lower component defines an upwardly open space, a lower part of said space being in the form of a well which, when the mould components are in contact, constitutes a downward extension of said moulding cavity so that it falls into said well, a plunger forming the bottom of said well, and means for displacing said mould components and said plunger relatively to one another thereby to reduce the volume of the well and displace mouldable material out of said well and into said moulding cavity.

9. Moulding apparatus as claimed in claim 8, and including means for displacing said plunger upwardly with respect to the lower mould component to reduce the volume of said well and displace mouldable material out of said well and into said moulding cavity.

10. Moulding apparatus as claimed in claim 8 and including means for immobilizing said plunger and means for displacing said mould components downwardly with respect to the plunger to reduce the volume of said well and displace mouldable material out of said well and into said moulding cavity.

11. A method of moulding which comprises feeding a charge of mouldable material into the cavity of a female mould structure comprising a fixed shaft and a reciprocable female mould, closing said cavity by inserting the spigot of a male mould into said cavity, and displacing said male mould and said female mould with respect to said shaft so that the shaft slides into said cavity, said spigot, an end surface of said shaft and surfaces of the female mould defining a mould cavity having the shape of the article to produced.

12. A method as claimed in claim 11, and comprising providing said spigot with a protruding rib which extends along the spigot at that end of the spigot which is last to enter the cavity, said rib contacting the female mould whereby a slit is moulded into said article.

13. A method as claimed in claim 11 and comprising providing a rib on said female mould, which rib contacts said spigot when the spigot is in the female mould.

14. A method as claimed in claim 12 and comprising providing a plurality of ribs which are spaced apart circumferentially thereby to mould an array of slits.

15. A cap comprising a skirt, a transverse end wall at one end of the skirt and a band at the other end of the skirt, the band being connected to the skirt by a plurality of bridges, the inner diameter of the band and the outer diameter of the skirt being such that the skirt can be forced into the band, the portion of the skirt that enters the band having slits therein which are open at the free edge of the skirt.

16. A method of capping a container which comprises pressing a cap as defined in claim 15 onto the neck of the container so that the bridges break and the skirt slides into the band, the band causing said slits to close-up whereby protruding formations on the inside of the band interlock with a protruding formation on the container to prevent the cap being removed without breaking the band.

17. A method as claimed in claim 16, wherein said band has a line of weakness so that it breaks upon pressure being applied thereto sufficient to slide it off the skirt.
